(19) United States
(12) Patent Application Publication
(10) Pub. No.: US 2008/0052920 A1
(43) Pub. Date: Mar. 6, 2008

(54) Diamond Cutter

(76) Inventor: Kimiko Sueda, Taito-ku (JP)

Correspondence Address: HAMRE, SCHUMANN, MUELLER & LARSON, P.C., P.O. BOX 2902, MINNEAPOLIS, MN, 55402-0902, US

(21) Appl. No.: 11/893,177

(22) Filed: Aug. 15, 2007

(30) Foreign Application Priority Data
Sep. 5, 2006 (JP) 20-2006-008026

(51) Int. Cl. B26B 9/00; B26B 1/00

(52) U.S. Cl. 30/350

(57) ABSTRACT

In a cutter that is used for bale packaging in the distribution industry, a cutter blade where a plurality of cutting lines are carved. If the cutting edge of the cutter blade becomes dull, the end of the cutter blade is broken off at the cutting line. The broken portion of the blade is considered a dangerous waste. However, solution to avoid the dangerous has not been considered. A cutter of the present invention includes a cutter blade which has a cutting edge, a pivot hole, locking notches, a gripper in which a pivot shaft is fitted into the pivot hole to perform the pivoting, a locking chamber which is formed in the gripper, a locking button having a locking protrusion which protrudes in the locking chamber, a coil spring which is disposed in the locking button, a sharpener main body which includes a diamond sharpener and a finger setting part for insertion and drawing, and a sharpener receiving chamber which is formed to receive the sharpener main body while the finger setting part for insertion and drawing is exposed. The cutting edge is made of titanium sintered material in which diamond particles having a particle size of 100 μm or less are arranged in a line.

### BACKGROUND OF THE INVENTION

1. Field of the Invention

The present invention relates to a diamond cutter. More particularly, the present invention pertains to a diamond cutter in which diamond particles are fixed to a cutting edge of a cutter blade made of titanium sintered material that are arranged in a line. Accordingly, the cutter blade significantly increases wear resistance of the cutting edge and durability, and does not need to be broken off.

2. Description of the Related Art

In a known cutter that is used to cut synthetic resin tape for bale packaging in the distribution industry or to cut a container such as a packing paper, generally, a cutter blade, which freely slides into a gripper, has a plurality of cutting lines that are arranged at an incline parallel to each other at regular intervals. If the cutting edge of the end of the knife becomes dull, the end of the cutter blade is broken off at the cutting line that is closest to the end, and the broken portion of the cutter blade is removed.

Throughout the world, a large amount of broken ends are generated by commonly used cutter blades and disposed of in a waste receptacle. Not only is the broken portion of the blade sharp and small, it has high specific gravity. Thus, the broken portion of the blade is a dangerous waste material, which becomes an element of environment pollution. However, resolution for the above-mentioned problems has not been considered, and resources are significantly squandered.

A grinding agent and a whetstone may be attached to the end of a sleeve, which is inserted into a main body 1 of the above-mentioned cutter, to grind the blade of the knife when the knife enters and exits. In this case, it is possible to desirably maintain the sharpness of the blade of the knife. With respect to this, a cutter blade, in which a groove where the grinding agent and the whetstone are provided is formed in a part that is attached to a rear portion of a main body and is capable of being used to break the end of the knife, is disclosed in Patent Document 1. Since the blade of the knife comes into direct contact with the part 5 to be ground, the durability of the blade of the knife is increased, thus economic efficiency is ensured. In addition, a cutter x that includes a blade body 1, a main body 2 supporting the blade body 1, and a detachable whetstone 3 attached to the main body 2 is disclosed in Patent Document 2. In the cutter, an entire body or a portion of at least one of a pair of lateral parts 21a and 21b on an external surface of the main body 2 that is spaced apart from the blade body 1 in a thickness direction of the blade body has an inclined surface in respect to the thickness directional central line L of the blade body 1. In the case when an cutting edge 13 of the blade body 1 is ground using the whetstone 3, the main body 2 is provided on a base 5 so that the inclined surface comes into contact with a desired surface 51 of the base 5. Thereby, the blade body 1 is tapered as moving from a back 14 of the blade to the end 15 of the blade while an upper side of the blade body is not deformed but a lower side of the blade body is deformed to be inclined upward.

[Patent Document 1] Japanese Utility Model Registration No. 3021710

[Patent Document 2] JP-A-2004-229744

However, in the Patent Document 1, the groove where the grinding agent and the whetstone are provided is formed in the part to break the end of the blade so as to grind the blade. The cutter blade is made of common steel. Even though the durability of the cutter blade is slightly increased, the blade still must be broken along the cutting line in order to ensure desirable sharpness. Furthermore, it is difficult to use the blade that is frequently ground in the field of labor due to the busy schedule. In addition, in the Patent Document 2, the whetstone 3 is removably provided in the main body 2. However, it is undesirable to apply the blade body 1 to a cutter such as a kitchen knife having a predetermined length.

### SUMMARY OF THE INVENTION

The present invention has been made to solve the above-mentioned problems, and it is an object of the present invention to provide a diamond cutter. The diamond cutter includes a cutter blade which has an cutting edge formed at one side thereof, a pivot hole which is formed through the cutter blade, locking notches which have semicircle shapes and are formed at both sides of the cutter blade while the notches correspond in position to the pivot hole, a gripper in which a pivot shaft is fitted into the pivot hole so that the cutter blade is freely pivoted at a front end of the gripper, a locking chamber which is formed in the gripper, a locking button which is provided in the locking chamber and from a lateral part of which a locking protrusion protrudes, a coil spring which is disposed in the locking button and presses to protrude the locking button, a sharpener main body which includes a diamond sharpener at a front end thereof and a finger setting part for insertion and drawing at a base end thereof, and a sharpener receiving chamber which is formed at the base end of the gripper to receive the sharpener main body while the finger setting part for insertion and drawing of the sharpener main body is exposed at the base end of the gripper. The cutting edge of the cutter blade is made of titanium sintered material in which diamond particles having a particle size of 100 μm or less are arranged in a line. In addition, an oxide film is formed on a surface of the cutter blade other than the cutting edge by anodizing.

In the diamond cutter according to the present invention, since the cutting edge of the cutter blade, which has a width of about 30 mm, and to which the diamond particles having a size of 100 μm or less and arranged in a line is made of titanium sintered material, the cutter blade has a wear resistance that is several to ten times as high as that of a known cutter blade made of steel. Therefore, it is unnecessary to break the cutter blade in use. Furthermore, in the case of when the cutter blade is used for a long time and becomes worn out, it is possible to grind the blade using the diamond sharpener that is received at the base end of the gripper for a short time. Additionally, in the case of when the cutter is not in used, the dangerous cutter blade and the diamond sharpener that is readily lost are capable of being stored in the gripper. Accordingly, the cutter does not contribute to environmental waste, while being very effective and of practical use.

### BRIEF DESCRIPTION OF THE DRAWINGS

The above and other features and advantages of the present invention will become more apparent by describing in detail preferred embodiments thereof with reference to the attached drawings in which:

FIG. 1 is a plan view of a diamond cutter according to an embodiment of the present invention;

FIG. 2 is a plan view of a cutter blade of the diamond cutter according to the embodiment of the present invention;

FIG. 3 is a plan view of a diamond sharpener of the diamond cutter according to the embodiment of the present invention;

FIG. 4 is a sectional view of a locking chamber of the diamond cutter according to the embodiment of the present invention, which is in a locked state; and

FIG. 5 is a sectional view of the locking chamber of the diamond cutter according to the embodiment of the present invention, which is in an unlocked state.

### DESCRIPTION OF THE PREFERRED EMBODIMENTS

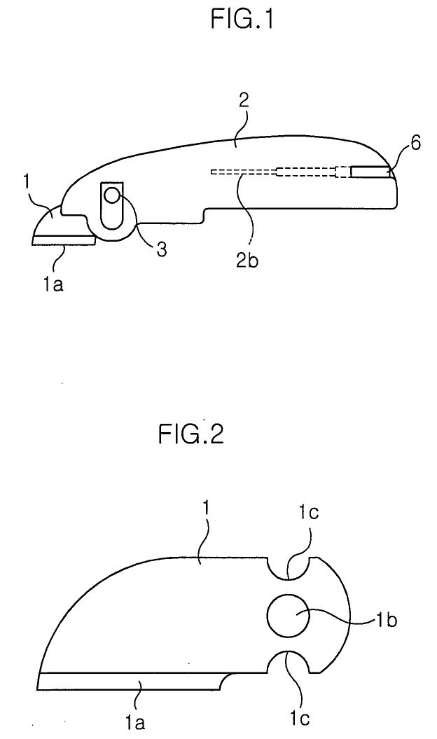

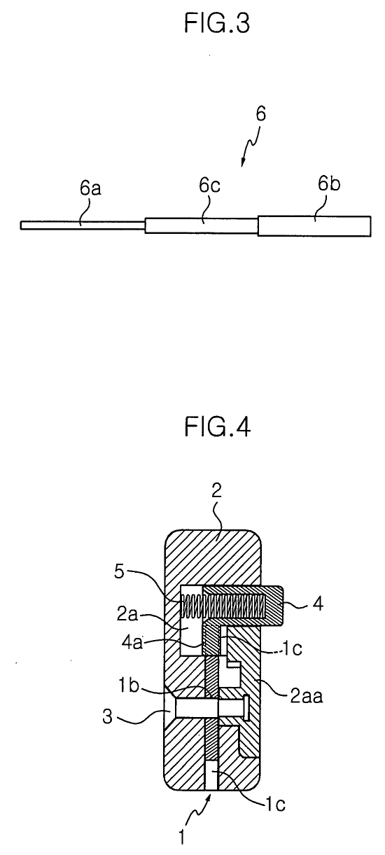

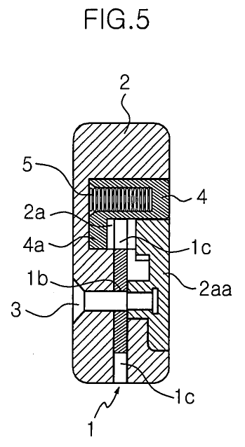

Diamond cutters for operation according to embodiments of the present invention will be described in detail with reference to the accompanying drawings hereinafter. FIG. 1 is a plan view of a diamond cutter according to an embodiment of the present invention, FIG. 2 is a plan view of a cutter blade of the diamond cutter according to the embodiment of the present invention, FIG. 3 is a plan view of a diamond sharpener of the diamond cutter according to the embodiment of the present invention, FIG. 4 is a sectional view of a locking chamber of the diamond cutter according to the embodiment of the present invention, which is in a locked state, and FIG. 5 is a sectional view of the locking chamber of the diamond cutter according to the embodiment of the present invention, which is in an unlocked state.

The present invention relates to a diamond cutter. More particularly, the present invention pertains to a diamond cutter in which diamond particles are fixed to a cutting edge 1a of a cutter blade 1 made of titanium sintered material that are arranged in a line. Accordingly, the cutter blade 1 significantly increases wear resistance of the cutting edge and the durability, and it does not need to be broken off. The diamond cutter includes a cutter blade 1 which has a cutting edge 1a formed at one side of a front end thereof, a pivot hole 1b which is formed through a base end of the cutter blade 1, locking notches 1c which have semicircular shapes and are formed at both sides of the cutter blade while the notches correspond in position to the pivot hole 1b, a gripper 2 in which a pivot shaft 3 is fitted into the pivot hole 1b so that the cutter blade 1 is freely pivoted at the front end of the gripper 2, a locking chamber 2a, which is formed in the gripper 2, a cup-shaped locking button 4 having a locking protrusion 4a, which protrudes from the side disposed in the locking chamber 2a, and is freely inserted into and drawn from the locking notch 1c, a coil spring 5 which is disposed in the locking button 4 and provides elastic force outward to protrude the locking button 4, a sharpener main body 6 which includes a diamond sharpener 6a having a plate shape at the front end thereof and a finger setting part for insertion and drawing 6b at a base end thereof, and a sharpener receiving chamber 2b which is longitudinally formed at the base end of the gripper 2 to receive the sharpener main body 6 while the finger setting part for insertion and drawing 6b of the sharpener main body 6 is exposed at the base end of the gripper 2. The cutting edge 1a of the cutter blade 1 is made of titanium sintered material in which diamond particles having a particle size of 100 μm or less are arranged in a line.

Furthermore, in the diamond cutter, an oxide film is formed on a surface of the cutter blade 1 other than the cutting edge 1a by anodizing.

That is, as shown in FIGS. 1 and 2, the cutter blade 1 has a cutting edge 1a that is formed at one side of the front end of the thin cutter blade 1 having a plate shape, that is, a lower side of the front end of the cutter blade 1. The front end has an acute angle to easily perform the cutting. A pivot hole 1b and locking notches 1c as described below, are formed in the base end. The base end has a circular arc shape in order to easily pivot the cutter blade 1 as described below.

The pivot hole 1b is formed in the base end of the cutter blade 1, and a pivot shaft 3 is provided through the pivot hole formed in a gripper 2 as described below to freely pivot.

The locking notches 1c are formed at both sides of the pivot hole 1b of the cutter blade 1, that is, in the figures, upper and lower sides of the base end of the cutter blade, while the notches correspond to the position of the pivot hole 1b. The notches are formed through the base end of the cutter blade 1 while the distances between the hole and the notches are the same on both sides. The locking notch 1c has a semicircular shape, and the locking protrusion 4a that protrudes from a locking button 4 as described below is inserted into and drawn from the notch 1c.

A user grips the gripper 2 while the diamond cutter is used, and the cutter blade 1 is provided at the front end of the gripper so that the pivot shaft 3 passes through the pivot hole 1b of the cutter blade 1. Thus, the cutter blade 1 is freely pivoted on the pivot shaft. Furthermore, a locking chamber 2a as described below is formed to lock the cutter blade 1, and a sharpener receiving chamber 2b as described below is formed in the base end.

As shown in FIGS. 4 and 5, the locking chamber 2a is formed in the vicinity of the pivot shaft 3 of the front end of the gripper 2. In the embodiment, a locking chamber wall 2aa is provided at a lateral part of the locking chamber 2a, and a through hole for button is formed to freely push in/out the locking button 4 as described below therethrough. Furthermore, the pivot shaft 3 is fixed in the locking chamber 2a by the locking chamber wall 2aa.

In addition, the locking button 4 that is provided in the locking chamber 2a has a cup shape, and the locking protrusion 4a having the semicircular shape that is freely inserted into and drawn from the locking notch 1c of the cutter blade 1 protrudes from a lateral part of the locking button. A coil spring 5 as described below is provided in the locking button.

The coil spring 5 uses axial elasticity in respect to the coil. The coil spring 5 is provided in the locking button 4, and an end of the coil spring comes into contact with an inner surface of the locking chamber 2a to continuously provide elasticity outward. Accordingly, the locking button 4 freely slides.

In the locked state shown in FIG. 4, the locking button 4 is supported by the elastic force of the coil spring 5 that is applied outward. Furthermore, the locking protrusion 4a that protrudes from the lateral part of the locking button 4 is inserted into the locking notch 1c of the cutter blade 1, and the pivoting of the cutter blade 1 is restricted, thereby the lock state is obtained. The lock state is obtained in respect to the use and the receiving of the cutter blade 1.

Additionally, in the unlock state shown in FIG. 5, in the case when the locking button 4 is pressed against the elastic force of the coil spring 5, the locking button is buried into the locking chamber 2a, and the locking protrusion 4a of the locking button 4 is separated from the locking notch 1c of the cutter blade 1. Accordingly, the cutter blade 1 is freely pivoted, and the use state is converted into the reception state or the reception state is converted into the use state by the pivoting of the cutter blade.

The sharpener main body 6 has the material and the shape that are useful to grind the cutting edge 1a. The cutting edge 1a is made of the titanium sintered material, and the diamond particles having the particle size of 100 μm or less as described below are arranged in a line in the cutting edge 1a. A diamond sharpener 6a having the plate shape is provided at the front end of the sharpener main body 6, and a finger setting part for insertion and drawing 6b is provided at the base end of the sharpener main body 6. The diamond sharpener and the finger setting part for insertion and drawing are integrally formed along with an intermediate member 6c. The resulting sharpener main body is easily inserted into and drawn from the sharpener receiving chamber 2b of the gripper 2 as described below.

The sharpener receiving chamber 2b is longitudinally formed at the base end of the gripper 2. Since the finger setting part for insertion and drawing 6b of the sharpener main body 6 is exposed at the base end of the gripper, the sharpener main body 6 is easily inserted into and drawn from the sharpener receiving chamber 2b.

In addition, the cutting edge 1a of the cutter blade 1 is made of titanium sintered material, and the diamond particles having the particle size of 100 μm or less are arranged in a line in the cutting edge. The cutting edge 1a is formed by compression molding the diamond particles along with the titanium alloy particles that contain pure titanium particles or 50 mass % or more of titanium particles and sintering the resulting substance. This is disclosed in the utility model which has been made by the applicant of the present invention, Japanese Patent No. 3641794. The length of the cutting edge is set to about 30 mm in consideration of convenience of the use. The wear resistance of the cutting edge 1a is several to ten times as high as that of a known cutter blade 1 which is made of common steel.

In a diamond cutter according to another embodiment of the present invention, an oxide film is formed on a surface of a cutter blade 1 other than a cutting edge 1a using anodizing. The oxide film has excellent antibiosis.

In the present invention, a cutting edge of a cutter blade of a diamond cutter is made of titanium sintered material in which diamond particles having the particle size of 100 μm or less are arranged in a line. Accordingly, the diamond cutter of the present invention has the following advantages. The cutting edge of the cutter blade has excellent corrosion resistance and wear resistance, it is unnecessary to break the end of the blade, and the cutting edge is capable of being ground by using a diamond sharpener that is received in the cutter for a short time in the case when the sharpness of the cutting edge is reduced, thus the cutter is capable of being used for a long time.

What is claimed is:

1. A diamond cutter comprising:
a cutter blade which has a cutting edge formed at one side of a front end thereof;
a pivot hole which is formed through a base end of the cutter blade;
locking notches which have semicircular shape and are formed at both sides of the cutter blade while the notches correspond in the position to the pivot hole;
a gripper in which a pivot shaft is fitted into the pivot hole so that the cutter blade is freely pivoted at the front end of the gripper;
a locking chamber which is formed in the gripper;
a cup-shaped locking button having a locking protrusion which protrudes from the side thereof disposed in the locking chamber, the locking protrusion being freely inserted into and drawn from the locking notch;
a coil spring which is disposed in the locking button and provides elastic force outward to protrude the locking button;
a sharpener main body which includes a diamond sharpener having a plate shape at a front end thereof and a finger setting part for insertion and drawing at a base end thereof; and
a sharpener receiving chamber which is longitudinally formed at the base end of the gripper to receive the sharpener main body while the finger setting part for insertion and drawing of the sharpener main body is exposed at the base end of the gripper,
wherein the cutting edge of the cutter blade is made of titanium sintered material in which diamond particles having a particle size of 100 μm or less are arranged in a line.

2. The diamond cutter as set forth in claim 1, wherein an oxide film is formed on a surface of the cutter blade other than the cutting edge by anodizing.
